(19) United States
(12) Patent Application Publication
(10) Pub. No.: US 2025/0256358 A1
(43) Pub. Date: Aug. 14, 2025

(54) SUBSTRATE MANUFACTURING METHOD

(71) Applicant: DISCO CORPORATION, Tokyo (JP)

(72) Inventor: Yuya Seto, Tokyo (JP)

(21) Appl. No.: 19/042,785

(22) Filed: Jan. 31, 2025

(30) Foreign Application Priority Data
Feb. 9, 2024 (JP) 2024-018317

(51) Int. Cl. B23K 26/53; B23K 26/067; B23K 103/00; B28D 5/00

(52) U.S. Cl. CPC B23K 26/53; B23K 26/0673; B28D 5/0011; B23K 2103/56

(57) ABSTRACT

A substrate manufacturing method includes applying a laser beam of a wavelength transmittable through a material of a workpiece, thereby forming a peel-off layer inside the workpiece, and after the forming of the peel-off layer, with the peel-off layer as a starting point of separation, separating the workpiece, thereby manufacturing a substrate. In the forming of the peel-off layer, by alternately repeating moving the workpiece and a focusing point at which the laser beam is focused relative to each other along a first direction, in a state in which the focusing point is positioned inside the workpiece, and moving the workpiece and a position at which the focusing point is formed relative to each other along a second direction perpendicular to the first direction, the peel-off layer including first modified portions and second modified portions which are alternately lined up in the second direction is formed.

### BACKGROUND OF THE INVENTION

### Field of the Invention

The present invention relates to a substrate manufacturing method of manufacturing a substrate having a thickness smaller than that of a workpiece from the workpiece.

### Description of the Related Art

Semiconductor devices are typically formed by use of a disc-shaped substrate. Also, the substrate is manufactured, for example, by cutting off a workpiece such as a cylindrical bulk called an ingot with use of a wire saw in such a manner as to separate a portion included in the workpiece having a predetermined thickness, from the workpiece (see, for example, Japanese Patent Laid-Open No. 2016-13929).

### SUMMARY OF THE INVENTION

A substrate having a thickness of substantially 150 μm, for example, is used for formation of semiconductor devices. Also, a thickness of a wire saw is, for example, substantially 300 um. Hence, in a case in which the wire saw is used to manufacture a substrate from the workpiece, for example, 60% to 70% of the workpiece is discarded as debris therefrom, thereby causing reduction of its productivity.

In view of this circumstance, the present invention has an object of providing a substrate manufacturing method of being capable of enhancing the productivity of a substrate at a time of manufacturing, from a workpiece, the substrate thinner than the workpiece.

In accordance with an aspect of the present invention, there is provided a substrate manufacturing method of manufacturing a substrate from a workpiece, the substrate having a thickness smaller than that of the workpiece. The method includes applying, to the workpiece, a laser beam of a wavelength transmittable through a material of the workpiece, thereby forming a peel-off layer inside the workpiece, and separating the workpiece with the peel-off layer as a starting point of separation, after the forming of the peel-off layer, thereby manufacturing the substrate. In the forming of the peel-off layer, by alternately repeating moving the workpiece and a focusing point at which the laser beam is focused relative to each other along a first direction, in a state in which the focusing point is positioned inside the workpiece, and moving the workpiece and a position at which the focusing point is formed relative to each other along a second direction perpendicular to the first direction, the peel-off layer including first modified portions and second modified portions which are alternately lined up in the second direction is formed, the first modified portion is formed at a first focusing point at which a first laser beam having first output power is focused, and the second modified portion is formed at a second focusing point at which a second laser beam having a second output power greater than the first output power is focused.

Note that, preferably, in the applying of the laser beam, the original laser beam of a wavelength transmittable through the material of the workpiece may be split into the first laser beam and the second laser beam, and in a state in which the first focusing point and the second focusing point which are spaced apart from each other in the second direction are positioned inside the workpiece, the workpiece and each of the first focusing point and the second focusing point are moved relative to each other along the first direction. More preferably, in the applying of the laser beam, the first focusing point may move inside the workpiece in the first direction, while preceding the second focusing point.

In addition, cracks that develop from the first modified portion may be smaller than cracks that develop from the second modified portion. Alternatively, cracks may not develop from the first modified portion, but cracks may develop from the second modified portion.

Further, the substrate manufacturing method according to the present invention may further include, after the forming of the peel-off layer to be performed such that a modified portion that is closest to one end of the workpiece in the second direction becomes the second modified portion and a modified portion that is closest to another end thereof becomes the first modified portion, but before the separating, moving the workpiece and the second focusing point relative to each other along the first direction, in a state in which the second focusing point is positioned in such a manner overlapping with the first modified portion that is closest to the other end. Alternatively, in the substrate manufacturing method according to the present invention, the forming of the peel-off layer may be performed such that a modified portion which comes closest to each end of the workpiece in the second direction becomes the second modified portion.

According to the present invention, after the peel-off layer is formed inside the workpiece, by separating the workpiece with the peel-off layer as a starting point of separation, the substrate is manufactured. Hence, compared to a case in which the substrate is manufactured from the workpiece with use of the wire saw, productivity of the substrate can be enhanced.

The above and other objects, features and advantages of the present invention and the manner of realizing them will become more apparent, and the invention itself will best be understood from a study of the following description and appended claims with reference to the attached drawings showing a preferred embodiment of the invention.

### BRIEF DESCRIPTION OF THE DRAWINGS

FIG. 1A is a perspective view schematically illustrating an example of an ingot;

FIG. 1B is a side view schematically illustrating the ingot depicted in FIG. 1A;

FIG. 2 is a flowchart schematically indicating an example of a substrate manufacturing method;

FIG. 3 is a view schematically illustrating an example of a laser processing apparatus for forming a peel-off layer inside the ingot;

FIG. 4 is a flowchart schematically indicating a procedure performed at a time of forming the peel-off layer;

FIG. 5A is a plan view schematically illustrating a manner in which the peel-off layer is formed inside the ingot;

FIG. 5B is an enlarged longitudinal sectional view schematically illustrating part of the ingot formed with the peel-off layer therein;

FIG. 6A is a side view schematically illustrating a manner in which a separating step is performed;

FIG. 6B is a side view schematically illustrating the manner in which the separating step is performed; and

FIG. 7 is a flowchart schematically indicating another example of a substrate manufacturing method.

### DETAILED DESCRIPTION OF THE PREFERRED EMBODIMENT

An embodiment of the present invention will be described with reference to the accompanying drawings. Note that the attached drawings are offered for easy understanding of the present invention and hence do not necessarily accurately reflect the products and/or methods implementing the present invention.

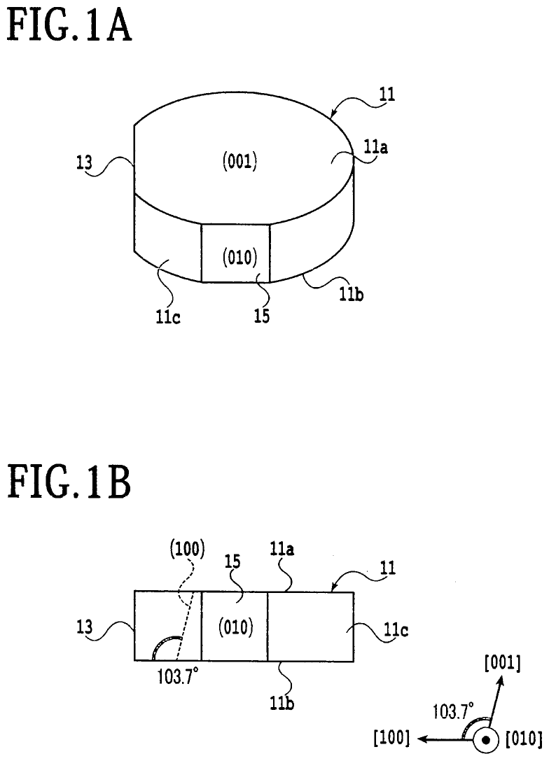

FIG. 1A is a perspective view schematically illustrating an example of an ingot. FIG. 1B is a side view schematically illustrating the ingot depicted in FIG. 1A. Note that, in FIGS. 1A and 1B, crystal planes of a material of the ingot are also illustrated. In addition, in FIG. 1B, crystal orientations of this material are also illustrated.

The material of an ingot 11 illustrated in FIGS. 1A and 1B is, for example, gallium oxide (β-Ga₂O₃) having a phase (hereinafter, simply referred to as “gallium oxide”). Gallium oxide has a wide-bandgap semiconductor with a bandgap of substantially 4.8 eV. Hence, gallium oxide is expected to be used as a material for a semiconductor device such as a power device.

Moreover, gallium oxide is a monoclinic crystal having such a crystal structure that an angle formed by a crystal orientation (a-axis) and a crystal orientation (c-axis) is 103.7° and an angle formed by a crystal orientation (b-axis) and each of the crystal orientation (a-axis) and the crystal orientation (c-axis) is 90°. Moreover, the ingot 11 depicted in FIGS. 1A and 1B has a front surface 11a and a back surface 11b that are in parallel with each other, and the front surface 11a and the back surface 11b each have a crystal plane {001} exposed therein (in this specification, for convenience, a plane that is exposed in the front surface 11a is called a crystal plane (001)).

Note that the ingot 11 is manufactured in such a manner that the crystal plane {001} is exposed in each of the front surface 11a and the back surface 11b. However, owing to a processing error or the like occurring in the manufacturing, a plane that is slightly inclined relative to the crystal plane {001} may be exposed in each of the front surface 11a and the back surface 11b. More specifically, in each of the front surface 11a and the back surface 11b of the ingot 11, a plane that forms an angle of equal to or less than 1° with the crystal plane {001} may be exposed.

Further, a side surface 11c of the ingot 11 has two plane portions for representing a crystal orientation of the material of the ingot 11, that is, a first orientation flat 13 and a second orientation flat 15, formed thereon. Also, the first orientation flat 13 is longer than the second orientation flat 15 and is formed in such a manner as to be positioned at the crystal orientation as viewed from the center of the ingot 11.

In addition, the second orientation flat 15 is formed in such a manner as to be positioned at the crystal orientation as viewed from the center of the ingot 11. In other words, the second orientation flat 15 is formed serving as such a plane in which the crystal plane (010) is exposed. Hence, in the ingot 11, the crystal plane (100) forms an obtuse angle of 103.7° with the front surface 11a or the back surface 11b and is orthogonal to the second orientation flat 15.

Note that the side surface 11c of the ingot 11 may not have one of or both the first orientation flat 13 and the second orientation flat 15 formed therein. In addition, the side surface 11c of the ingot 11 may have a cut-out portion (notch) for indicating the crystal orientation of the material of the ingot 11 formed therein, in place of the first orientation flat 13 and the second orientation flat 15.

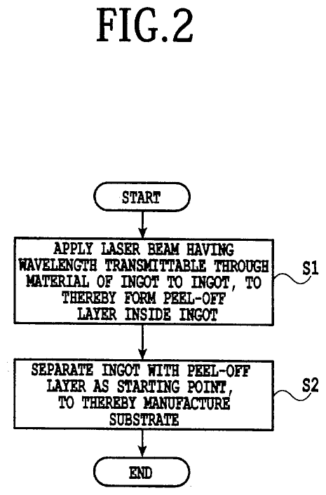

FIG. 2 is a flowchart schematically indicating one example of a substrate manufacturing method of manufacturing a substrate thinner than the ingot 11 serving as the workpiece, from the ingot 11. In this method, first, a laser beam having a wavelength transmittable through the material of the ingot 11 is applied to the ingot 11, thereby forming a peel-off layer inside the ingot 11 (peel-off layer forming step S1). Note that the peel-off layer is a layer which has modified portions in which a crystal structure of the material of the ingot 11 is disordered and cracks extending from the modified portions.

In the peel-off layer forming step S1, the modified portions in multiple columns are sequentially formed inside the ingot 11. However, with use of a laser beam having a constant output power maintained, when the modified portions in multiple columns are sequentially formed from an edge of the ingot 11, more specifically, when the modified portion positioned at the edge of the ingot 11 in a direction perpendicular to a direction in which each of the modified portions extends is first formed and the other modified portion is also formed in such a manner as to be adjacent to the previously formed modified portion in the relevant direction, greatly longer cracks may develop from the other modified portion that have been newly formed in the course of formation of the other modified portions.

More specifically, with use of the laser beam having a constant output power maintained, when the modified portions are formed in this order, internal stresses generated in the ingot 11 along with formation of the modified portions are applied to a newly formed modified portion, and as a result, cracks may overdevelop from the newly formed modified portion. In other words, when internal stresses accumulated along with formation of the modified portions becomes too large, greatly longer cracks may be formed from the newly formed modified portion in such a manner as to release the accumulated internal stresses.

In this case, the cracks develop to a region of the ingot 11 where formation of the cracks is not intended, causing difficulty in subsequent formation of desired modified portions at the relevant region. In addition, in this case, the proportion of the cracks developing along a thickness direction of the ingot 11 becomes large, causing possibility of lowering of productivity of the substrate at the time of manufacture of the substrate from the ingot 11.

To address this problem, in the peel-off layer forming step S1, in order to prevent the cracks from excessively developing from the modified portions, the output power of the laser beam is adjusted, to thereby form multiple columns of modified portions inside the ingot 11. More specifically, in the peel-off layer forming step S1, there is formed a peel-off layer including first modified portions and second modified portions which are lined up alternately in a direction perpendicular to a direction in which the modified portions extend.

Here, the first modified portion is formed at a focusing point (first focusing point) at which a laser beam (first laser beam) having a relatively small output power (first output power) is focused. Also, the second modified portion is formed at a focusing point (second focusing point) at which a laser beam (second laser beam) having a relatively large output power, that is, output power (second output power) larger than the first output power, is focused.

Note that the first output power may be set to such a value allowing the cracks to develop from the first modified portion or set to such a value preventing the cracks from developing from the first modified portion. Even if the first output power is set to a value allowing the cracks to develop from the first modified portion, the first output power is smaller than the second output power, and accordingly, the cracks developing from the first modified portion are smaller than the cracks developing from the second modified portion.

In a case in which the peel-off layer is formed in this manner, it is possible to control a range in which the cracks developing from the second modified portion can be developed to a portion between a pair of adjacent first modified portions. Hence, in the peel-off layer forming step S1, it is possible to prevent the greatly longer cracks from developing from the second modified portion in the course of performing the peel-off layer forming step S1.

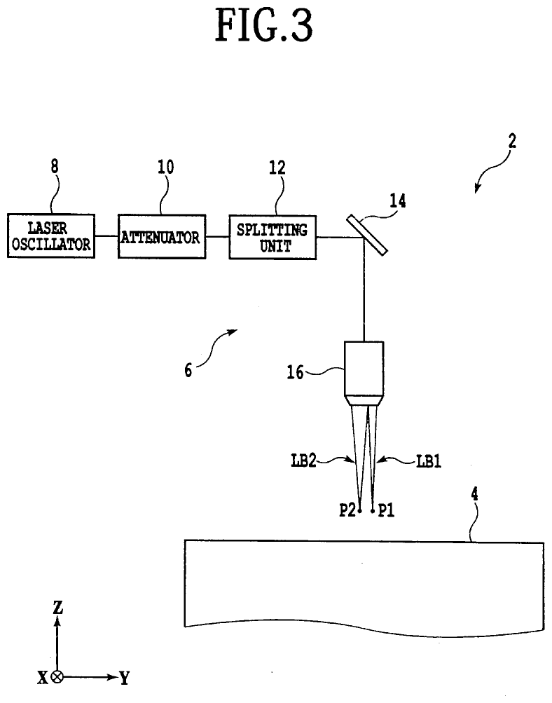

FIG. 3 is a view schematically illustrating an example of a laser processing apparatus for forming a peel-off layer inside the ingot 11. Note that, in FIG. 3, a direction indicated with an arrow X (X direction) and a direction indicated with an arrow Y (Y direction) are directions perpendicular to each other on a horizontal plane, and a direction (vertical direction) indicated with an arrow Z (Z direction) is perpendicular to each of the X direction and the Y direction. Also, in FIG. 3, some of constituent components of the laser processing apparatus are illustrated in a block form.

A laser processing apparatus 2 illustrated in FIG. 3 includes a chuck table 4 having a circular holding surface that is substantially in parallel with the horizontal plane. The chuck table 4 is, for example, coupled with a suction mechanism having an ejector and the like (not illustrated), and a rotational mechanism having, for example, a pulley, a motor, and the like (not illustrated).

When the suction mechanism is operated, a suction force is applied to a space in the vicinity of the holding surface of the chuck table 4. Hence, when the suction mechanism is operated in a state in which the ingot 11 is placed on the holding surface, the ingot 11 is held under suction on the holding surface of the chuck table 4.

Moreover, when the rotational mechanism is operated, the chuck table 4 rotates with a straight line passing through the center of the holding surface and extending along the Z direction as a rotational axis. For example, the rotational mechanism causes the chuck table 4 to rotate such that the second orientation flat 15 of the ingot 11 held on the holding surface of the chuck table 4 is in parallel with the X direction.

In addition, above the chuck table 4, a laser beam applying unit 6 is provided. The laser beam applying unit 6 has, as a laser medium, a laser oscillator 8 having neodymium-doped yttrium aluminum garnet (Nd:YAG) and the like, for example.

The laser oscillator 8 emits a laser beam (for example, a pulsed laser beam with a frequency of 30 kHz and a pulse width of 4 ns) of a wavelength (for example, 1064 nm or 1342 nm) passing through the material of the ingot 11 (for example, gallium oxide). The output power of this laser beam is adjusted by the attenuator 10, and then, the laser beam is supplied to the splitting unit 12.

The splitting unit 12 has a spatial light modulator and/or a diffraction optical element (DOE) including a liquid crystal phase control element which is referred to as a liquid crystal on silicon (LCOS), for example. Further, for example, the splitting unit 12 splits the laser beam (original laser beam) whose output power is adjusted by the attenuator 10 into a first laser beam LB1 having a first output power and a second laser beam LB2 having a second output power larger than the first output power.

Each of the laser beams LB1 and LB2 is reflected on a mirror 14 to be guided to a head 16. The head 16 houses, for example, a focusing lens (not illustrated) which focuses each of the laser beams LB1 and LB2. Each of the laser beams LB1 and LB2 which are focused by the focusing lens is emitted toward a side of the holding surface of the chuck table 4, in short, directly below the head 16, with a central region of a lower surface of the head 16 as an emitting region.

Note that a first focusing point P1 at which the first laser beam LB1 is focused and a second focusing point P2 at which the second laser beam LB2 is focused are identical with each other in position (height) of the Z direction, for example, but are different from each other in position of the Y direction. Moreover, both of the focusing points P1 and P2 may be identical with each other and may be different from each other in position of the X direction.

Further, the head 16 of the laser beam applying unit 6 and an optical system (for example, the mirror 14) for guiding the laser beams LB1 and LB2 to the head 16 are coupled with, for example, a moving mechanism (not illustrated) including a ball screw and the like. When the moving mechanism is operated, an emitting region of each of the laser beams LB1 and LB2 is moved along the X direction, the Y direction, and/or the Z direction.

Also, in the laser processing apparatus 2, when the moving mechanism is operated, the first focusing point P1 at which the first laser beam LB1 emitted from the head 16 to the side of the holding surface of the chuck table 4 is focused and the second focusing point P2 at which the second laser beam LB2 emitted from the head 16 to the side of the holding surface of the chuck table 4 is focused can be adjusted in position (coordinate) in the X direction, the Y direction, and/or the Z direction.

When the peel-off layer forming step S1 is performed in the laser processing apparatus 2, first, the ingot 11 is placed on the holding surface of the chuck table 4 such that the front surface 11a faces upward. Next, the suction mechanism is operated such that the ingot 11 is held under suction on the chuck table 4.

Next, for example, in such a manner that the second orientation flat 15 is in parallel with the X direction, the rotational mechanism causes the chuck table 4 to rotate. That is, in such a manner that the crystal orientation of gallium oxide is in parallel with the X direction and the crystal orientation thereof is in parallel with the Y direction, the rotational mechanism causes the chuck table 4 to rotate.

Next, in such a manner that a linear region of the ingot 11 (for example, a linear region along the X direction positioned in the vicinity of the second orientation flat 15) along the X direction positioned in the vicinity of one end of the Y direction is positioned along the X direction as viewed from the head 16, in plan view, the moving mechanism moves the head 16 and the like along the X direction and/or the Y direction.

Next, the peel-off layer including the first modified portion formed by emitting the first laser beam LB1 having the first output power and the second modified portion formed by emitting the second laser beam LB2 having the second output power, the first modified portion and the second modified portion being alternately lined up in the Y direction, is formed inside the ingot 11.

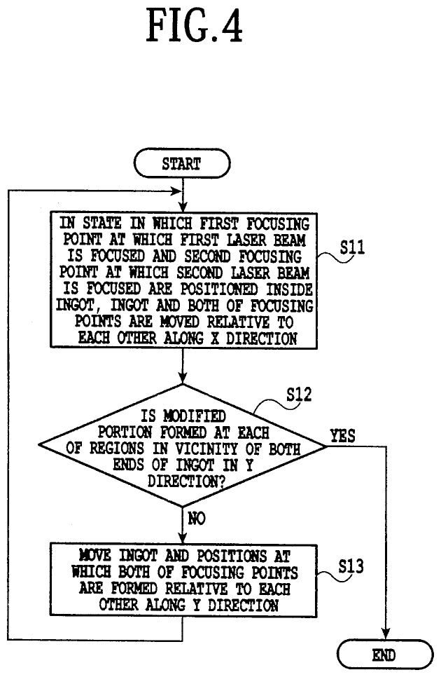

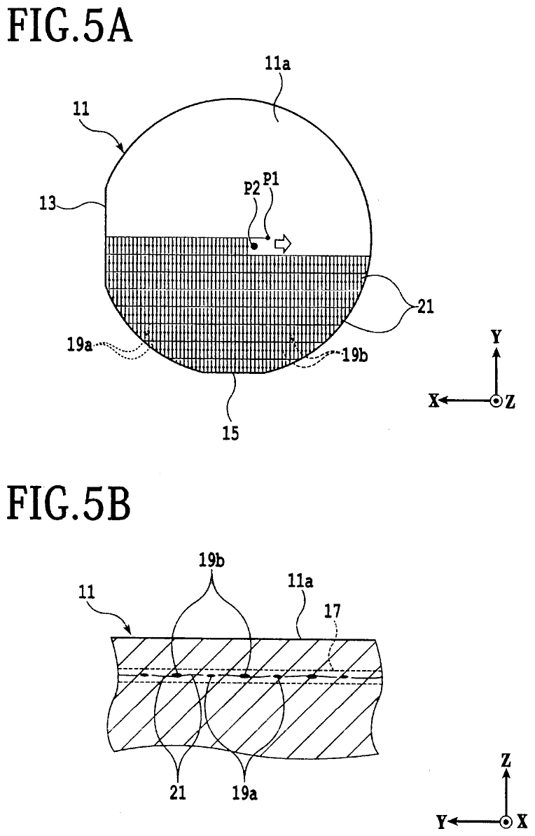

FIG. 4 is a flowchart schematically indicating a procedure performed at a time of forming such a peel-off layer. Also, FIG. 5A is a plan view schematically illustrating a manner in which the peel-off layer is formed inside the ingot 11, and FIG. 5B is an enlarged longitudinal sectional view schematically illustrating part of the ingot 11 formed with the peel-off layer therein.

When a peel-off layer 17 illustrated in FIG. 5B is formed, first, in a state in which the first focusing point P1 at which the first laser beam LB1 is focused and the second focusing point P2 at which the second laser beam LB2 is focused are positioned inside the ingot 11, the ingot 11 and both of the focusing points P1 and P2 are moved relative to each other along the X direction (laser beam applying step S11).

More specifically, in the laser beam applying step S11, while both of the laser beams LB1 and LB2 are emitted from the head 16, in such a manner that both of the focusing points P1 and P2 pass from one end of the ingot 11 to the other end thereof in the X direction at a predetermined speed (for example, 390 mm/s), the moving mechanism moves the head 16 and the like along the X direction. That is, with a direction parallel to the crystal orientation of gallium oxide as a scanning direction, both of the laser beams LB1 and LB2 are emitted to the ingot 11.

At this time, both of the laser beams LB1 and LB2 are obtained by causing the original laser beam to be split such that respective positions of both of the focusing points P1 and P2 in the X direction, the Y direction, and the Z direction satisfy the following conditions, for example.

First, in the X direction, in such a manner that the first focusing point P1 moves inside the ingot 11, preceding the second focusing point P2, both of the focusing points P1 and P2 are positioned. That is, in the laser beam applying step S11, in a case in which the moving mechanism moves the head 16 and the like in the X direction, the focusing point P1 is positioned on the X direction side as viewed from the focusing point P2.

In addition, both of the focusing points P1 and P2 are positioned such that both of the focusing points P1 and P2 are spaced apart from each other in the Y direction and the second focusing point P2 is closer to one end of the ingot 11 (more specifically, is closer to the second orientation flat 15) in the Y direction than the first focusing point P1. Moreover, both of the focusing points P1 and P2 are positioned at the same height in the Z direction.

In the laser beam applying step S11, the first modified portion 19a and the second modified portion 19b are formed inside the ingot 11 (more specifically, in two columns of linear regions each extending along the X direction). Note that the first modified portion 19a is formed at the first focusing point P1 at which the first laser beam LB1 is focused and the second modified portion 19b is formed at the second focusing point P2 at which the second laser beam LB2 is focused.

In addition, when the first modified portion 19a and the second modified portion 19b are formed inside the ingot 11, a volume of the ingot 11 is expanded, and an internal stress is generated in the ingot 11. This internal stress becomes greater in proportion to a size of each of the first modified portion 19a and the second modified portion 19b, that is, the output power of each of the laser beams LB1 and LB2.

When the internal stress becomes great, cracks develop from each of the first modified portion 19a and the second modified portion 19b in such a manner as to release this internal stress. Hence, setting the output power of each of the laser beams LB1 and LB2 appropriately allows for control whether or not the cracks 21 develop from each of the first modified portion 19a and the second modified portion 19b and the size of the cracks 21, to some extent.

For example, in the laser beam applying step S11, in such a manner causing cracks smaller than the cracks 21 developing from the second modified portion 19b to develop from the first modified portion 19a, the output power of each of the laser beams LB1 and LB2 is set. Alternatively, in the laser beam applying step S11, in such a manner developing the cracks 21 from the second modified portion 19b but preventing the cracks from developing from the first modified portion 19a, the output power of each of the laser beams LB1 and LB2 may be set. Note that, in FIG. 5A and FIG. 5B, for convenience, the peel-off layer 17 not including the cracks which develop from the first modified portion 19a is illustrated.

In addition, as for gallium oxide, the crystal plane (100) is most likely to be cleaved, and the crystal plane (001) is second most likely to be cleaved. In this case, in the laser beam applying step S11, the scanning direction of both of the laser beams LB1 and LB2 is set to a direction in which an angle formed between the scanning direction of both of the laser beams LB1 and LB2 and the crystal plane (100) is larger (more specifically, set to a direction parallel to the crystal orientation) In this case, the ingot 11 is less likely to be cleaved on the crystal plane (100) of gallium oxide. That is, in the laser beam applying step S11, generation of cracks largely developing along the thickness direction of the ingot 11 is prevented.

When the first focusing point P1 at which the first laser beam LB1 emitted from the head 16 is focused and the second focusing point P2 at which the second laser beam LB2 emitted from the head 16 is focused pass through the other end of the ingot 11 in the X direction, the laser beam applying step S11 is completed.

When the laser beam applying step S11 is performed in this manner, the second modified portion 19b and the cracks 21 developing from the second modified portion 19b are formed at a linear region along the X direction positioned in the vicinity of the one end of the ingot 11 (more specifically, the second orientation flat 15) in the Y direction, and the first modified portion 19a is formed at a linear region along the X direction positioned slightly farther than this region from the second orientation flat 15.

Then, if the modified portion (more specifically, the first modified portion 19a or the second modified portion 19b) is not formed at each of the regions in the vicinity of both ends of the ingot 11 in the Y direction (step S12: NO), the ingot 11 and the positions at which both of the focusing points P1 and P2 are formed are moved relative to each other along the Y direction (moving step S13).

In the moving step S13, in plan view, in such a manner that the head 16 is positioned in the X direction as viewed from the linear region that is slightly farther from the second orientation flat 15 than the region in which the laser beam is previously applied, the moving mechanism moves the head 16 and the like by a predetermined distance (for example, 0.1 to 0.2 mm) along the Y direction. Note that this distance is set to a value twice greater than a center-to-center distance between both of the focusing points P1 and P2 in the Y direction, for example, in the laser beam applying step S11.

Next, with a direction opposite to the X direction as the scanning direction of both of the laser beams LB1 and LB2, the laser beam applying step S11 is performed. At this time, both of the laser beams LB1 and LB2 are obtained by causing the original laser beam to be split such that the positions of both of the focusing points P1 and P2 in the X direction, the Y direction, and the Z direction satisfy the abovementioned conditions, for example. Note that, in this laser beam applying step S11, since the direction opposite to the X direction is the scanning direction of both of the laser beams LB1 and LB2, the focusing point P1 is positioned on the side of the direction opposite to the X direction as viewed from the focusing point P2.

Moreover, until irradiation of the first laser beam LB1 or the second laser beam LB2 to a region in the vicinity of the other end of the ingot 11 (for example, a region farthest from the second orientation flat 15) in the Y direction is completed, the moving step S13 and the laser beam applying step S11 are alternately repeated. That is, relative movement of the ingot 11 and the positions in which both of the focusing points P1 and P2 are formed along the Y direction and irradiation of both of the laser beams LB1 and LB2 to the ingot 11 with the X direction or the direction opposite thereto as the scanning direction are alternately repeated.

Then, when the modified portion (more specifically, the first modified portion 19a or the second modified portion 19b) is formed at each of the regions in the vicinity of both ends of the ingot 11 in the Y direction (step S12: YES), the peel-off layer forming step S1 is completed.

Note that, in the abovementioned peel-off layer forming step S1, it is preferable that the peel-off layer 17 be formed in such a manner that the modified portion which is closest to not only the one end of the ingot 11 in the Y direction but also the other end thereof is the second modified portion 19b. In this case, it becomes easier to cause cracks 21 to develop to both ends of the ingot 11 in the Y direction, to thereby separate the ingot 11 in the separating step S2 which will be described later.

In order to form such a peel-off layer 17, for example, it is sufficient that, while a distance L between the one end to the other end of the ingot 11 in the Y direction is recognized, a distance D₀ from the one end of the ingot 11 in the Y direction to the focusing point P2 in the first round of the laser beam applying step S11, an interval I between both of the focusing points P1 and P2 in the Y direction in each round of the laser beam applying step S11, a distance D_{y} by which the head 16 and the like move in the moving step S13, and the number of times of performance n in the laser beam applying step S11 satisfy the following expression (1).

$$[ Expression 1 ]$$

$$\{ {D}_{0} + ( n - 1 ) {D}_{Y} \} < L < \{ {D}_{0} + ( n - 1 ) {D}_{Y} + I \} \qquad ( 1 )$$

More specifically, in a case in which the distance Do, the interval I, and the distance D_{y} are set in the ratio of 1:2:4, it is sufficient that the distance D_{y} and the number of times of performance n should be set in such a manner as to satisfy the following expression (2).

$$[ Expression 2 ]$$

$$\{ \frac{{D}_{Y}}{4} + ( n - 1 ) {D}_{Y} \} < L < \{ \frac{{D}_{Y}}{4} + ( n - 1 ) {D}_{Y} + \frac{{D}_{Y}}{2} \} \to \frac{4 n - 3}{4} {D}_{Y} < L < \frac{4 n - 1}{4} {D}_{Y} \to \frac{4 L}{4 n - 1} < {D}_{Y} < \frac{4 L}{4 n - 3} \qquad ( 2 )$$

Moreover, in a case in which the distance D₀, the interval I, and the distance D_{y} are set in the ratio of 1:1:2, it is sufficient that the distance D_{y} and the number of times of performance n should be set in such a manner as to satisfy the following (3).

$$[ Expression 3 ]$$

$$\{ \frac{{D}_{Y}}{2} + ( n - 1 ) {D}_{Y} \} < L < \{ \frac{{D}_{Y}}{2} + ( n - 1 ) {D}_{Y} + \frac{{D}_{Y}}{2} \} \to \frac{2 n - 1}{2} {D}_{Y} < L < {nD}_{Y} \to \frac{L}{n} < {D}_{Y} < \frac{2 L}{2 n - 1} \qquad ( 3 )$$

In addition, in a case in which the distance D₀, the interval I, and the distance D_{Y} are set in the ratio of 2:1:2, it is sufficient that the distance D_{y} and the number of times of performance n should be set in such a manner as to satisfy the following expression (4).

$$[ Expression 4 ]$$

$$\{ {D}_{Y} + ( n - 1 ) {D}_{Y} \} < L < \{ {D}_{Y} + ( n - 1 ) {D}_{Y} + \frac{{D}_{Y}}{2} \} \to {nD}_{Y} < L < \frac{2 n + 1}{2} {D}_{Y} \to \frac{2 L}{2 n + 1} < {D}_{Y} < \frac{L}{n} \qquad ( 4 )$$

Further, in the abovementioned peel-off layer forming step S1, irradiation of the first laser beam LB1 to the ingot 11 and irradiation of the second laser beam LB2 to the ingot 11 are performed in the same round of laser beam applying step S11, however, they may be performed in separate rounds of the laser beam applying step S11.

For example, in the peel-off layer forming step S1, after the laser beam applying step S11 is performed in multiple times for forming all of the multiple columns of the first modified portions 19a, the laser beam applying step S11 may be performed in multiple times for forming all of the multiple columns of the second modified portions 19b.

Alternatively, in the peel-off layer forming step S1, the first modified portion 19a and the second modified portion 19b may be formed alternately. For example, in the peel-off layer forming step S1, the laser beam applying step S11 in which the X direction is set as the scanning direction of the second laser beam LB2 and the abovementioned moving step S13, and the laser beam applying step S11 in which the direction opposite to the X direction is set as the scanning direction of the first laser beam LB1 and the abovementioned moving step S13 may sequentially be repeated.

However, in these cases, the number of times of performance in each of the laser beam applying step S11 and the moving step S13 which are performed in the peel-off layer forming step S1 may generally double. Hence, in this case, throughput in the laser processing apparatus 2 is reduced.

In view of such a drawback, it is preferable that irradiation of the first laser beam LB1 to the ingot 11 and irradiation of the second laser beam LB2 to the ingot 11 be performed in the same round of the laser beam applying step S11.

Also, in the abovementioned peel-off layer forming step S1, although the laser beam applying step S11 is performed such that the first focusing point P1 at which the first laser beam LB is focused precedes the second focusing point P2 at which the second laser beam LB2 is focused inside the ingot 11 in the X direction, the laser beam applying step S11 may be performed such that both of the focusing points P1 and P2 run side by side. That is, in the peel-off layer forming step S1, the laser beam applying step S11 may be performed in a state in which positions of both of the focusing points P1 and P2 in the X direction match with each other.

However, in this case, the cracks 21 that largely obliquely develop in plan view may develop from the second modified portion 19b. That is, in this case, the cracks 21 may develop in such a manner as to cross a region of the ingot 11 where the first modified portion 19a is to be formed but the first modified portion 19a has not yet been formed. Hence, in this case, the first modified portion 19a is not formed as intended, and the thickness of the peel-off layer 17 that is formed inside the ingot 11 increases, thereby causing lowering of productivity in the manufacturing of the substrate from the ingot 11.

In view of such a drawback, it is preferable that the laser beam applying step S11 be performed such that the first focusing point P1 precedes the second focusing point P2 inside the ingot 11 in the X direction.

Moreover, in the abovementioned peel-off layer forming step S1, the direction parallel to the crystal orientation of gallium oxide (the X direction or the opposite direction thereto) is set as the scanning direction of both of the laser beams LB1 and LB2. However, a direction that is not parallel to the crystal orientation of gallium oxide may be set as the scanning direction of both of the laser beams LB1 and LB2.

Note that, however, when the scanning direction of both of the laser beams LB1 and LB2 is parallel to the crystal orientation of gallium oxide, the percentage of the cracks 21 that develop along the crystal plane (100) parallel to the crystal orientation may increase. In a case in which the percentage of the cracks 21 that develop along the crystal plane (100) increases, the thickness of the peel-off layer 17 that is formed inside the ingot 11 increases, resulting in lowering of the productivity in the manufacturing of a substrate from the ingot 11.

In addition, in this case, the percentage of the cracks 21 that develop along the crystal plane (001), that is, the cracks 21 that develop in parallel to the front surface 11a of the ingot 11, decreases, so that a width of the peel-off layer 17 (a length in a direction perpendicular to each of the thickness direction of the ingot 11 and the scanning direction of both of the laser beams LB1 and LB2) formed inside the ingot 11 decreases. Hence, in this case, in the moving step S13, the distance by which the head 16 and the like move has to be reduced, causing lowering of the throughput in the laser processing apparatus 2.

In view of these drawbacks, in order to enhance the productivity and the throughput in the manufacturing of a substrate from the ingot 11, the scanning direction of both of the laser beams LB1 and LB2 is preferably set such that an angle formed between the scanning direction of both of the laser beams LB1 and LB2 and a straight line parallel to the crystal orientation of gallium oxide becomes greater, that is, the angle formed between the scanning direction of both of the laser beams LB1 and LB2 and the straight line parallel to the crystal orientation becomes smaller.

Moreover, in the abovementioned peel-off layer forming step S1, irradiation of both of the laser beams LB1 and LB2 to the ingot 11 may be performed along only one direction (for example, along the X direction). That is, in the peel-off layer forming step S1, irradiation of both of the laser beams LB1 and LB2 to the ingot 11 may be repeated in a condition that a direction opposite to the relevant one direction (for example, a direction opposite to the X direction) is not assigned to the scanning direction of both of the laser beams LB1 and LB2 but the relevant one direction is assigned to the scanning direction.

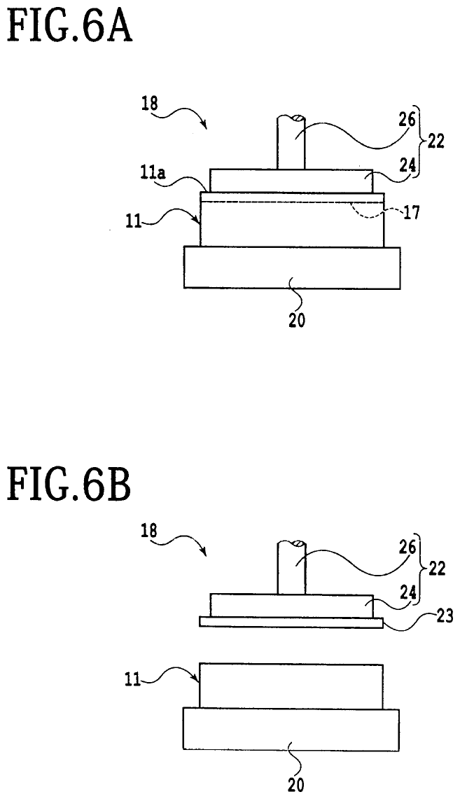

After the peel-off layer forming step S1 is performed, with the peel-off layer 17 as a starting point of separation, the ingot 11 is separated, so that a substrate is manufactured (separating step S2). FIG. 6A and FIG. 6B are each a side view schematically illustrating a manner in which the separating step S2 is performed. This separating step S2 is performed by a separation apparatus 18. The separation apparatus 18 includes a chuck table 20 having the same structure as that of the chuck table 4 depicted in FIG. 3.

The chuck table 20 is coupled with a table-side suction mechanism (not illustrated). This table-side suction mechanism has, for example, a vacuum pump and the like. When the table-side suction mechanism is operated, a suction force is applied to a space in the vicinity of the holding surface of the chuck table 20. Hence, when the table-side suction mechanism is operated in a state in which the ingot 11 is placed on the holding surface, the ingot 11 is held under suction on the holding surface of the chuck table 20.

Above the chuck table 20, a separation unit 22 is provided. The separation unit 22 has a suction plate 24 that has a plurality of suction ports formed in a lower surface thereof. The plurality of suction ports are communicated with a separation unit-side suction mechanism such as a vacuum pump through a suction path that is formed inside the suction plate 24. When the separation unit-side suction mechanism is operated, a suction force is applied to a space in the vicinity of the lower surface of the suction plate 24.

In addition, a vertical-direction-moving mechanism 26 is coupled with an upper surface of the suction plate 24. The vertical-direction-moving mechanism 26 has, for example, a ball screw, a motor, and the like. When the vertical-direction-moving mechanism 26 is operated, the suction plate 24 moves along the vertical direction.

In the separation apparatus 18, when the separating step S2 is performed, first, in a state in which the chuck table 20 and the suction plate 24 are sufficiently apart from each other, in such a manner that the front surface 11a of the ingot 11 in which the peel-off layer 17 is formed faces upward, the ingot 11 is placed on the holding surface of the chuck table 20. Next, the table-side suction mechanism is operated in such a manner that the ingot 11 is held under suction on the holding surface of the chuck table 20.

Next, in such a manner as to bring the lower surface of the suction plate 24 into contact with the front surface 11a of the ingot 11, the vertical-direction-moving mechanism lowers the suction plate 24 (see FIG. 6A). Next, in such a manner that the front surface 11a side of the ingot 11 is sucked upward, the separation unit-side suction mechanism is operated. Next, in such a manner that the suction plate 24 is spaced apart from the chuck table 20, the vertical-direction-moving mechanism 26 lifts the suction plate 24 (see FIG. 6B).

Hence, such an external force that the front surface 11a side and the back surface 11b side of the ingot 11 are separated from each other is applied to the ingot 11, and accordingly, the cracks 21 included in the peel-off layer 17 further develop. As a result, with the peel-off layer 17 as a starting point of separation, the ingot 11 is separated, so that a substrate 23 is manufactured. As above, the separating step S2 is completed, that is, the method of manufacturing the substrate indicated in FIG. 2 is completed.

In the method of manufacturing the substrate indicated in FIG. 2, after the peel-off layer 17 is formed inside the ingot 11, the ingot 11 is separated with the peel-off layer 17 as a starting point of separation, whereby the substrate 23 is manufactured. As a result, compared to a case in which a substrate 23 is manufactured from the ingot 11 with use of the wire saw, it is possible to enhance the productivity of the substrate 23.

Note that the abovementioned details are merely one mode of the present invention, and the present invention is not limited the abovementioned details. For example, in the peel-off layer forming step S1 according to the present invention, it is sufficient that the ingot 11, the first focusing point P1 at which the first laser beam LB1 is focused, and/or the second focusing point P2 at which the second laser beam LB2 is focused be moved relative to each other, and hence, a structure therefor is not limited to any particular one.

More specifically, the peel-off layer forming step S1 may be performed in a laser processing apparatus in which a moving mechanism that causes the chuck table 4 to move along each of the X direction, the Y direction, and/or the Z direction is provided.

Alternatively, the peel-off layer forming step S1 may be performed with use of a laser processing apparatus in which a scanning optical system that can change the direction(s) of the first laser beam LB1 and/or the second laser beam LB2 emitted from the head 16 is provided in the laser beam applying unit 6. Note that the scanning optical system includes, for example, a galvanoscanner, an acousto-optic deflector (AOD), a polygon mirror, and/or the like.

Moreover, in the separating step S2 according to the present invention, as an external force for manufacturing the substrate 23, ultrasonic vibration may be applied to the ingot 11. That is, in the separating step S2, in place of or prior to application of such an external force that the front surface 11a side and the back surface 11b side of the ingot 11 are separated from each other, ultrasonic vibration may be applied to the front surface 11a side of the ingot 11.

In addition, in a case in which the peel-off layer forming step S1 is performed such that a modified portion that is closest to the one end of the ingot 11 in the Y direction (more specifically, the second orientation flat 15) is the second modified portion 19b and that a modified portion that is closest to the other end of the ingot 11 in the Y direction is the first modified portion 19a, the substrate manufacturing method according to the present invention may include a step of reinforcing a region in the vicinity of the other end of the ingot 11 as a starting point of separation after the peel-off layer forming step S1 but before the separating step S2.

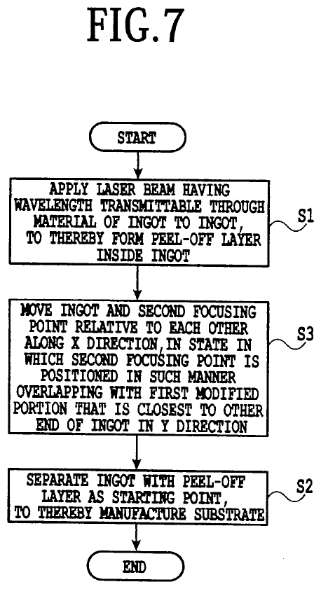

That is, the substrate manufacturing method according to the present invention may include a step of facilitating separation of the ingot 11 in the separating step S2, by, for example, developing the cracks 21 to the other end of the ingot 11 in the Y direction. FIG. 7 is a flowchart schematically indicating one example of the substrate manufacturing method including such a step described above.

In this method, after the peel-off layer forming step S1 but before the separating step S2, by positioning the second focusing point P2 in such a manner overlapping with the first modified portion 19a that is closest to the other end of the ingot 11 in the Y direction, the ingot 11 and the second focusing point P2 are moved relative to each other along the X direction (final laser beam applying step S3).

The final laser beam applying step S3 is performed as in the laser beam applying step S11 described above, for example, except that the first laser beam LB1 is not emitted from the head 16 but the second laser beam LB2 only is emitted.

More specifically, first, in such a manner that the first modified portion 19a that is closest to the other end of the ingot 11 is positioned in the X direction as viewed from the head 16, in plan view, the moving mechanism moves the head 16 and the like along the X direction and/or the Y direction. Then, in such a manner that the focusing point P2 passes from the one end of the ingot 11 in the X direction to the other end thereof as a predetermined speed, while the second laser beam LB2 is emitted from the head 16, the moving mechanism moves the head 16 and the like along the X direction.

Alternatively, the final laser beam applying step S3 may be performed as in the laser beam applying step S11 described above, also including a point that both the first laser beam LB1 and the second laser beam LB2 are emitted from the head 16. In other words, the final laser beam applying step S3 may be performed as in the laser beam applying step S11 described above, except that it is performed such that the focusing point P1 does not pass the inner side of the ingot 11.

Moreover, the workpiece used in the substrate manufacturing method according to the present invention may be an ingot manufactured such that a crystal plane other than the crystal plane {001} of gallium oxide (for example, the crystal plane (100)) is exposed in the front surface.

In addition, the workpiece used in the substrate manufacturing method according to the present invention may be a bare wafer having a thickness twice greater than and five-fold less than that of a substrate manufactured, for example. Note that the bare wafer is manufactured by separating the ingot 11, as in the method described above, for example. In this case, it can also be said that the substrate 23 is manufactured by repeating twice the method described above.

Alternatively, the workpiece used in the substrate manufacturing method according to the present invention may be a device wafer manufactured by forming semiconductor devices on one surface of this bare wafer. In this case, it is preferable that the laser beam be applied to the device wafer from a side on which semiconductor devices of the device wafer are not formed, in order to prevent an adverse effect on the semiconductor devices.

In addition, materials of the workpiece used in the substrate manufacturing method according to the present invention is not limited to gallium oxide. For example, the workpiece may be a single crystal made of silicon (Si), silicon carbide (Sic), gallium nitride (GaN), lithium tantalate (LiTaO₃:LT), or lithium niobate (LiNbO₃:LN).

Other structures, methods, and the like according to the abovementioned embodiment can be implemented by appropriately being modified within a scope not departing from the object of the present invention.

The present invention is not limited to the details of the above described preferred embodiment. The scope of the invention is defined by the appended claims and all changes and modifications as fall within the equivalence of the scope of the claims are therefore to be embraced by the invention.

What is claimed is:

1. A substrate manufacturing method of manufacturing a substrate from a workpiece, the substrate having a thickness smaller than that of the workpiece, the method comprising:
applying, to the workpiece, a laser beam of a wavelength transmittable through a material of the workpiece, thereby forming a peel-off layer inside the workpiece; and
separating the workpiece with the peel-off layer as a starting point of separation, after the forming of the peel-off layer, thereby manufacturing the substrate, wherein,
in the forming of the peel-off layer,
by alternately repeating
moving the workpiece and a focusing point at which the laser beam is focused relative to each other along a first direction, in a state in which the focusing point is positioned inside the workpiece, and
moving the workpiece and a position at which the focusing point is formed relative to each other along a second direction perpendicular to the first direction,
the peel-off layer including first modified portions and second modified portions which are alternately lined up in the second direction is formed,
the first modified portion is formed at a first focusing point at which a first laser beam having first output power is focused, and
the second modified portion is formed at a second focusing point at which a second laser beam having a second output power greater than the first output power is focused.

2. The substrate manufacturing method according to claim 1, wherein,
in the applying of the laser beam,
the original laser beam of a wavelength transmittable through the material of the workpiece is split into the first laser beam and the second laser beam, and in a state in which the first focusing point and the second focusing point which are spaced apart from each other in the second direction are positioned inside the workpiece, the workpiece and each of the first focusing point and the second focusing point are moved relative to each other along the first direction.

3. The substrate manufacturing method according to claim 2, wherein,
in the applying of the laser beam, the first focusing point moves inside the workpiece in the first direction, while preceding the second focusing point.

4. The substrate manufacturing method according to claim 1, wherein
cracks that develop from the first modified portion are smaller than cracks that develop from the second modified portion.

5. The substrate manufacturing method according to claim 1, wherein
cracks do not develop from the first modified portion, but cracks develop from the second modified portion.

6. The substrate manufacturing method according to claim 1, further comprising:
after the forming of the peel-off layer to be performed such that a modified portion that is closest to one end of the workpiece in the second direction becomes the second modified portion and a modified portion that is closest to another end thereof becomes the first modified portion, but before the separating, moving the workpiece and the second focusing point relative to each other along the first direction, in a state in which the second focusing point is positioned in such a manner overlapping with the first modified portion that is closest to the other end.

7. The substrate manufacturing method according to claim 2, further comprising:
after the forming of the peel-off layer to be performed such that a modified portion that is closest to one end of the workpiece in the second direction becomes the second modified portion and a modified portion that is closest to another end thereof becomes the first modified portion, but before the separating, moving the workpiece and the second focusing point relative to each other along the first direction, in a state in which the second focusing point is positioned in such a manner overlapping with the first modified portion that is closest to the other end.

8. The substrate manufacturing method according to claim 3, further comprising:
after the forming of the peel-off layer to be performed such that a modified portion that is closest to one end of the workpiece in the second direction becomes the second modified portion and a modified portion that is closest to another end thereof becomes the first modified portion, but before the separating, moving the workpiece and the second focusing point relative to each other along the first direction, in a state in which the second focusing point is positioned in such a manner overlapping with the first modified portion that is closest to the other end.

9. The substrate manufacturing method according to claim 4,
after the forming of the peel-off layer to be performed such that a modified portion that is closest to one end of the workpiece in the second direction becomes the second modified portion and a modified portion that is closest to another end thereof becomes the first modified portion, but before the separating, moving the workpiece and the second focusing point relative to each other along the first direction, in a state in which the second focusing point is positioned in such a manner overlapping with the first modified portion that is closest to the other end.

10. The substrate manufacturing method according to claim 5,
after the forming of the peel-off layer to be performed such that a modified portion that is closest to one end of the workpiece in the second direction becomes the second modified portion and a modified portion that is closest to another end thereof becomes the first modified portion, but before the separating, moving the workpiece and the second focusing point relative to each other along the first direction, in a state in which the second focusing point is positioned in such a manner overlapping with the first modified portion that is closest to the other end.

11. The substrate manufacturing method according to claim 1, wherein
the forming of the peel-off layer is performed such that a modified portion which comes closest to each end of the workpiece in the second direction becomes the second modified portion.

12. The substrate manufacturing method according to claim 2,
the forming of the peel-off layer is performed such that a modified portion which comes closest to each end of the workpiece in the second direction becomes the second modified portion.

13. The substrate manufacturing method according to claim 3,
the forming of the peel-off layer is performed such that a modified portion which comes closest to each end of the workpiece in the second direction becomes the second modified portion.

14. The substrate manufacturing method according to claim 4, wherein
the forming of the peel-off layer is performed such that a modified portion which comes closest to each end of the workpiece in the second direction becomes the second modified portion.

15. The substrate manufacturing method according to claim 5,
the forming of the peel-off layer is performed such that a modified portion which comes closest to each end of the workpiece in the second direction becomes the second modified portion.
